(19) United States
(12) Patent Application Publication
(10) Pub. No.: US 2016/0370629 A1
(43) Pub. Date: Dec. 22, 2016

(54) DISPLAY PANEL

(71) Applicant: GIANTPLUS TECHNOLOGY CO., LTD, Miaoli County (TW)

(72) Inventors: Chia-Jung Chuang, Miaoli County (TW); Chia-Cheng Hsu, Taipei City (TW); Yi-Ming Fang, Taipei City (TW)

(21) Appl. No.: 14/846,829

(22) Filed: Sep. 7, 2015

(30) Foreign Application Priority Data
Jun. 16, 2015 (TW) 104119440

(51) Int. Cl. G02F 1/1339; G02F 1/1335

(52) U.S. Cl. CPC G02F 1/13394; G02F 1/1339; G02F 1/133514; G02F 1/133512

(57) ABSTRACT

A display panel includes a first substrate, a second substrate, a seal, a display medium and a plurality of the first supporting structures. The second substrate is opposite to the first substrate in a top-bottom manner. The seal, the display medium and the plurality of the first supporting structures are disposed between the first substrate and the second substrate. The seal has a frame-like shape to define a set area and the display medium and the plurality of the first supporting structures are located within the set area. Besides, each first supporting structure abuts against the first substrate and the second substrate and has a supporting area, wherein a ratio of the supporting area of the first supporting structures to the set area is 0.03% to 0.08%.

### CROSS-REFERENCE TO RELATED APPLICATION

This application claims the priority benefit of Taiwan application serial no. 104119440, filed on Jun. 16, 2015. The entirety of the above-mentioned patent application is hereby incorporated by reference herein and made a part of this specification.

### BACKGROUND OF THE INVENTION

Field of the Invention

The invention is related to a display panel, and particularly related to a display panel which optimizes a display frame.

Description of Related Art

In recent years, the market of electronic products has been growing rapidly; as a result, various electronic products have been developed and improved rapidly as well. In terms of displays, as the demand for clearer and more specific screen definition arises, a variety of displaying technologies have been launched one after another. Nowadays, liquid crystal display (LCD) is the mainstream product on the market.

The LCD works based on the theory that optical anisotropy and dielectric anisotropy of liquid crystal molecules are utilized as a light valve to realize different display effects with different gray levels. Since liquid crystal molecule is not solid and has flowability, an upper and a lower substrate that are opposite to each other in a top-bottom manner and a seal disposed between the substrates are required for packaging. In addition, the change in thickness of the liquid crystal layer affects the optical effect exhibited by the liquid crystal layer. Therefore, the liquid crystal display needs to be equipped with a structure that provides support between the two substrates so as to maintain the thickness of the liquid crystal layer.

### SUMMARY OF THE INVENTION

The invention provides a display panel which may improve quality of a display frame.

The invention provides a display panel including a first substrate, a second substrate, a seal, a display medium and a plurality of supporting structures. The second substrate and the first substrate are opposite to each other in a top-bottom manner. The seal is disposed between the first substrate and the second substrate and has a frame-like shape to define a set area. The display medium is disposed between the first substrate and the second substrate and located in the set area. The plurality of first supporting structures are disposed between the first substrate and the second substrate and located in the set area. Each of the first supporting structures abuts against the first substrate and the second substrate, and each of the first supporting structures has a supporting area. A ratio of the supporting areas of the first supporting structures to the set area is 0.03% to 0.08%.

In an embodiment of the invention, the set area of the display panel includes a display region area and a periphery region area. The periphery region area is disposed between the display region area and the seal.

In an embodiment of the invention, the first supporting structures of the display panel are divided into a first portion in the display region and a second portion in the periphery region. A ratio of an overall supporting area of the first portion in the display region area to an area of the display region area is identical to a ratio of an overall supporting area of the second portion in the periphery region area to an area of the periphery region area.

In an embodiment of the invention, the first supporting structures in the display panel are divided into a first portion in the display region and a second portion in the periphery region. A ratio of an overall supporting area of the first portion in the display region area to an area of the display region area is 0.03% to 0.08%. A ratio of an overall supporting area of the second portion in the periphery region area to an area of the periphery region area is 0.03% to 0.08%.

In an embodiment of the invention, each first supporting structure of the display panel includes a color filter layer stack, a column and an active element layer stack. The color filter layer stack is disposed between the column and the first substrate. The active element layer stack is disposed between the column and the second substrate. A first end of the column abuts against the color filter layer stack, and a second end of the column abuts against the active element layer stack.

In an embodiment of the invention, a supporting area of each first supporting structure of the display panel is a contact area of the second end of each first supporting structure and the active element layer stack.

In an embodiment of the invention, the active element layer stack of the display panel includes a first metal layer, a semiconductor layer and a second metal layer. The semiconductor layer is disposed between the first metal layer and the second metal layer, and the first metal layer is disposed between the semiconductor layer and the second substrate.

In an embodiment of the invention, the color filter layer stack of the display panel includes a light shielding layer and a filter layer. The light shielding layer is disposed between the filter layer and the first substrate.

In an embodiment of the invention, the filter layer of the display panel is a red filter layer, a blue filter layer, a green filter layer, a yellow filter layer or a white filter layer.

In an embodiment of the invention, the area of the first end of the column in the display panel fully contacts the color filter layer stack.

In an embodiment of the invention, the display panel further includes a plurality of second supporting structures disposed between the first substrate and the second substrate and located in the set area. Each second supporting structure protrudes toward the second substrate from the first substrate and forms a gap, such that a portion of the display medium is disposed between the second supporting structure and the second substrate.

In an embodiment of the invention, each second supporting structure of the display panel includes a color filter layer stack and a column. The color filter layer stack is disposed between the column and the first substrate. Meanwhile, a first end of the column is connected to the color filter layer stack, and a portion of the display medium exists between a second end of the column and the second substrate.

In an embodiment of the invention, the color filter layer stack of the display panel includes a light shielding layer, and the light shielding layer is disposed between the column and the first substrate.

In an embodiment of the invention, the color filter layer stack of the display panel further includes a filter layer which is disposed between the light shielding layer and the column.

In an embodiment of the invention, the display panel further includes an active element layer stack which is disposed between the second substrate and the display medium and corresponds to the second end of the column, and the portion of the display medium is disposed between the active element layer stack and the second end of the column.

In an embodiment of the invention, the active element layer stack of the display panel includes a first metal layer which is disposed between the display medium and the second substrate.

In an embodiment of the invention, the active element layer stack of the display panel further includes a second metal layer. The first metal layer is disposed between the second metal layer and the second substrate.

In an embodiment of the invention, the active element layer stack of the display panel further includes a semiconductor layer. The semiconductor layer is disposed between the first metal layer and the second metal layer. The first metal layer is disposed between the semiconductor layer and the second substrate.

Based on the above, in the embodiment of the invention, the display panel mitigates or reduces the edge mura effect and enhances quality of the display frame via the design that the ratio of an overall supporting area of the first portion in the display region area to an are of the display region area and the ratio of an overall supporting area os the second portion in the periphery region area to an area of the periphery region area are set in a specific range or identical. In addition, some of the embodiments of the invention, the ratio of the supporting area is further adjusted to achieve better quality of the display frame. Moreover, the invention further provides additional supporting force by the second supporting structure to improve the quality of the display frame.

In order to make the aforementioned features and advantages of the invention more comprehensible, embodiments accompanying figures are described in detail below.

### BRIEF DESCRIPTION OF THE DRAWINGS

FIG. 1 is a top view illustrating a display panel according to an embodiment of the invention.

FIG. 2 is a sectional schematic view illustrating the display panel shown by FIG. 1 along sectional line Y-Y′.

FIG. 3 is an enlargement view illustrating a portion of a first supporting structure shown by FIG. 2.

FIG. 4A is a top view illustrating an area of a first end shown by FIG. 3.

FIG. 4B is a top view illustrating an area of a second end shown by FIG. 3.

FIG. 5 is a top view illustrating a display panel according to another embodiment of the invention.

FIG. 6 is a sectional schematic view illustrating a display panel shown by FIG. 5 along sectional line Z-Z′.

FIG. 7A is an enlargement view illustrating a portion of a second supporting structure shown by FIG. 6.

FIG. 7B is an enlargement view illustrating a second supporting structure according to another embodiment.

FIG. 7C is an enlargement view illustrating a second supporting structure according to another embodiment.

### DESCRIPTION OF EMBODIMENTS

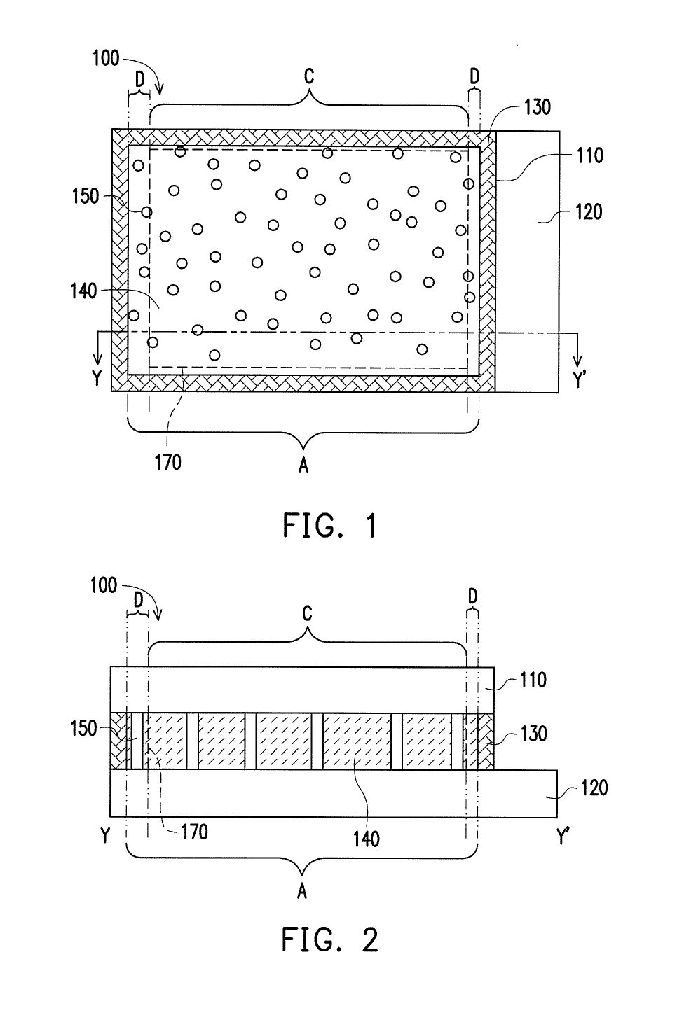

FIG. 1 is a top view illustrating a display panel according to an embodiment of the invention, and FIG. 2 is a sectional schematic view illustrating the display panel shown by FIG. 1 along sectional line Y-Y′. Referring to FIGS. 1 and 2, a display panel 100 includes a first substrate 110, a second substrate 120, a seal 130, a display medium 140 and a plurality of first supporting structures 150. The second substrate 120 and the first substrate 110 are opposite to each other in a top-bottom manner The seal 130 is disposed between the first substrate 110 and the second substrate 120, and the seal 130 is coated along a periphery of the first substrate 110. Therefore, the seal 130 has a frame-like shape to define a set area A. The second substrate 120 covers the seal 130 and is opposite to the first substrate 110 in a top-bottom manner. That is, the seal 130 is disposed to assemble the first substrate 110 to the second substrate 120. The display medium 140 is disposed between the first substrate 110 and the second substrate 120 and located in the set area A. A plurality of first supporting structures 150 are disposed between the first substrate 110 and the second substrate 120 and located in the set area A. Each first supporting structure 150 abuts against the first substrate 110 and the second substrate 120 to maintain the thickness of the display medium 140. In other words, in the embodiment, the display medium 140, e.g. a liquid crystal layer, is sealed in a space encircled by the first substrate 110, the second substrate 120 and the seal 130. The first supporting structure 150 is also located inside the space.

In the embodiment, the set area A includes a display region area C and a periphery region area D. In terms of FIG. 1 and FIG. 2, the display region area C is an area encircled by dotted line 170. The periphery region area D is between the dotted line 170 and the seal 130. Specifically, the display region area C refers to the display screen area that can be viewed by the user when the display panel 100 is practically used in products. For example, the display panel 100 is assembled to an outer casing to constitute a display screen, and a portion of the set area A that is covered by the outer casing is the periphery region area D. The portion of the set area A that is not covered by the outer casing is the exposed display region area D. Therefore, the boundary between the display region area C and the periphery region area D may vary depending on the products actually used. In addition, the display region area C may be regarded as an effective display area, and the periphery region area D may be regarded as an area between the effective display area and the seal 130. In other words, the display region area C is provided with a pixel structure for displaying an image, and the periphery region area D may be provided with a trace or wiring for transmitting a signal, a circuit element for realizing driving the pixel or a positioning structure for positioning and so on. Based on the division of the above areas, the first supporting structures 150 may be divided into a first portion located in the display region C and a second portion located in the periphery region D.

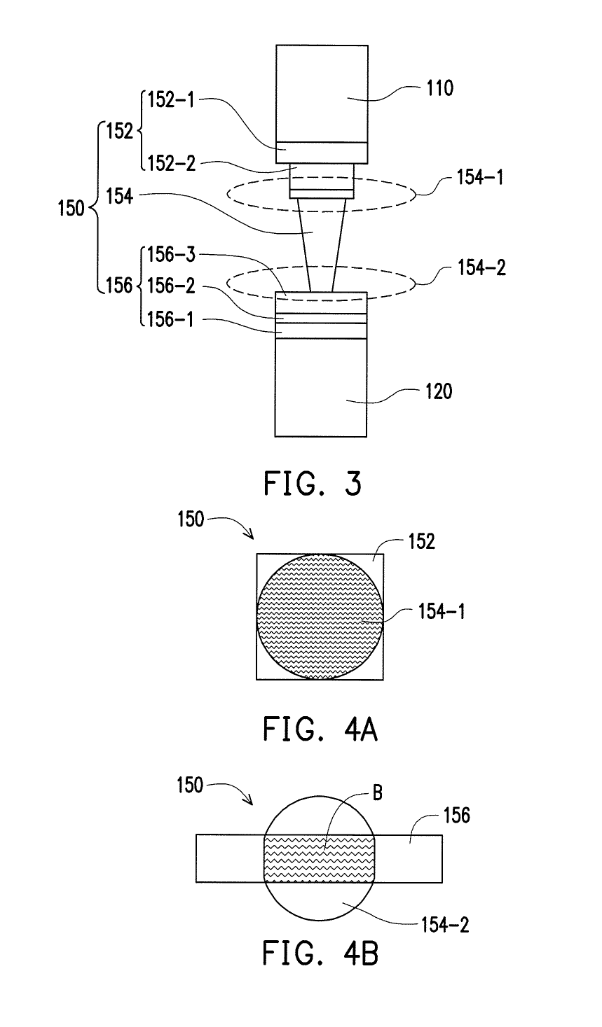

FIG. 3 is an enlargement view illustrating the first supporting structure shown by FIG. 2. FIG. 4A is a top view illustrating an area of a first end shown by FIG. 3 and FIG. 4B is a top view illustrating an area of a second end shown by FIG. 3. As FIGS. 3, 4A and 4B show, each first supporting structure 150 includes a color filter layer stack 152, a column 154 and an active element layer stack 156. The color filter layer stack 152 is disposed between the column 154 and the first substrate 110. The active element layer stack 156 is disposed between the column 154 and the second substrate 120. A first end 154-1 of the column 154 abuts against the color filter layer stack 152, and a second end 154-2 of the column 154 abuts against the active element layer stack 156.

In the embodiment, the material of the column 154 may be a photo-reactive material, i.e. photoresist material. The photoresist material may be categorized into positive photoresist and negative photoresist depending on different photo-reactive mechanisms, and both of which are suitable for manufacturing the column 154. The manufacturing method for the column 154 utilizes a photolithography process in which steps such as coating, exposing, developing and post-baking the photoresist material are performed so as to obtain desired size and distribution. Moreover, in FIG. 3, a sectional area of the column 154 gradually decreases toward the second substrate 120 from the first substrate 110. In another embodiment, the exposing energy or type of material may be adjusted in the exposing and developing processes such that the column 154 may be formed in the manner that the sectional area of the column 154 at the first end 154-1 is identical with the sectional area of the column 154 at the second end 154-2.

In the process of manufacturing the display panel 100, the column 154 is formed on the color filter layer stack 152 first, and the first substrate 110 and the second substrate 120 are assembled in a top-bottom manner so the column 154 abuts against the active element layer stack 156. Accordingly, the area of the column 154 at the first end 154-1 may fully contact the color filter layer stack 152 as shown by FIG. 4A, and the column 154 may only partially contact the active element layer stack 156 at the second end 154-2 to define a supporting area B as shown by FIG. 4B, which should not be construed as a limitation to the invention. In other embodiments, the area of the active element layer stack 156 may be equal to or larger than the area of the column 154 so that the column 154 fully contacts and abuts against the active element layer stack 156 at the second end 154-2 such that the supporting area B is equal to the area of the column 154 at the second end 154-2.

In the process of manufacturing the display panel 100 shown by FIGS. 1 and 2, when the first substrate 110 and the second substrate 120 are assembled together, if assembling pressure is inconsistently applied to different regions, a gap difference may be generated between the two substrates, causing display unevenness. Therefore, in the embodiment, the ratio of the overall supporting area B of the first portion of first supporting structures 150 in the display region area C to an area of the display region area C is equal to the ratio of the overall supporting area B of the second portion of first supporting structure 150 in the periphery region area D to an area of the periphery region area D. In the meantime, the ratio of the supporting areas B of the first supporting structures 150 to the set area A ranges from 0.03% to 0.08%. In other words, the ratio of the supporting areas B of a portion of the first supporting structures 150 (i.e. the first portion of first supporting structures 150) in the display region area C to an area of the display region area C is 0.03% to 0.08%, and the ratio of the supporting area B of another portion of the first supporting structures 150 (i.e. the second portion of first supporting structures 150) in the periphery region area D to an area of the periphery region area D is 0.03% to 0.08%.

Generally speaking, the ratio of the supporting areas B of the first supporting structures 150 to an area of the set area A may be further adjusted depending on the design requirement of different products. Accordingly, the ratio of the sum of the supporting areas B to an area of the set area A may range from 0.04% to 0.06%. In another embodiment of the invention, the area ratio of supporting areas B of the first portion in the display region area C to the display region area C is 0.04% to 0.06%, and the area ratio of supporting area B of the second portion in the periphery region area D to the periphery region area D is 0.04% to 0.06%. The first supporting structure 150 is configured to maintain thickness uniformity of the display medium 140 between the first substrate 110 and the second substrate 120 in the display panel 100 to avoid the defect of unsatisfactory display quality caused by ununiform thickness of the display medium 140.

In the embodiment, the color filter layer stack 152 includes a light shielding layer 152-1 and a filter layer 152-2. The light shielding layer 152-1 is disposed between the filter layer 152-2 and the first substrate 110, wherein the filter layer 152-2 is at least one of a red filter layer, a blue filter layer, a green filter layer, a yellow filter layer and a white filter layer. In another embodiment, the color filter layer stack 152 may only include the light shielding layer 152-1 without the filter layer 152-2, which should not be construed as a limitation to the invention. The light shielding layer 152-1 may be manufactured by using Cr-BM (Black Matrix, BM), Resin-BM or other materials having good light shieldability (or high optical density, OD), good uniformity, high heat resistance and chemical resistance. The material of the filter layer 152-2 includes a color resin material. The light shielding layer 152-1 and the filter layer 152-2 of the color filter layer stack 152 may constitute a color filter pattern array in the display region area C so the display panel 100 may display a color image.

In the embodiment, the active element layer stack 156 includes a first metal layer 156-1, a semiconductor layer 156-2 and a second metal layer 156-3. The semiconductor layer 156-2 is disposed between the first metal layer 156-1 and the second metal layer 156-3. The first metal layer 156-1 is disposed between the semiconductor layer 156-2 and the second substrate 120. In another embodiment, the active element layer stack 156 may include the first metal layer 156-1. In further another embodiment, the active element layer stack 156 may include the first metal layer 156-1 and the second metal layer 156-3. In other words, the active element layer stack 156 may include at least one or more of the first metal layer 156-1, the semiconductor layer 156-2 and the second metal layer 156-3, which should not be construed as a limitation to the invention. The first metal layer 156-1, the semiconductor layer 156-2 and the second metal layer 156-3 of the active element layer stack 156 may constitute a plurality of scan lines, data lines, active elements, capacitor structures or a combination thereof in the display region area C for driving the display medium 140. That is to say, the active element layer stack 156 is formed by an existing material layer in the display panel 100.

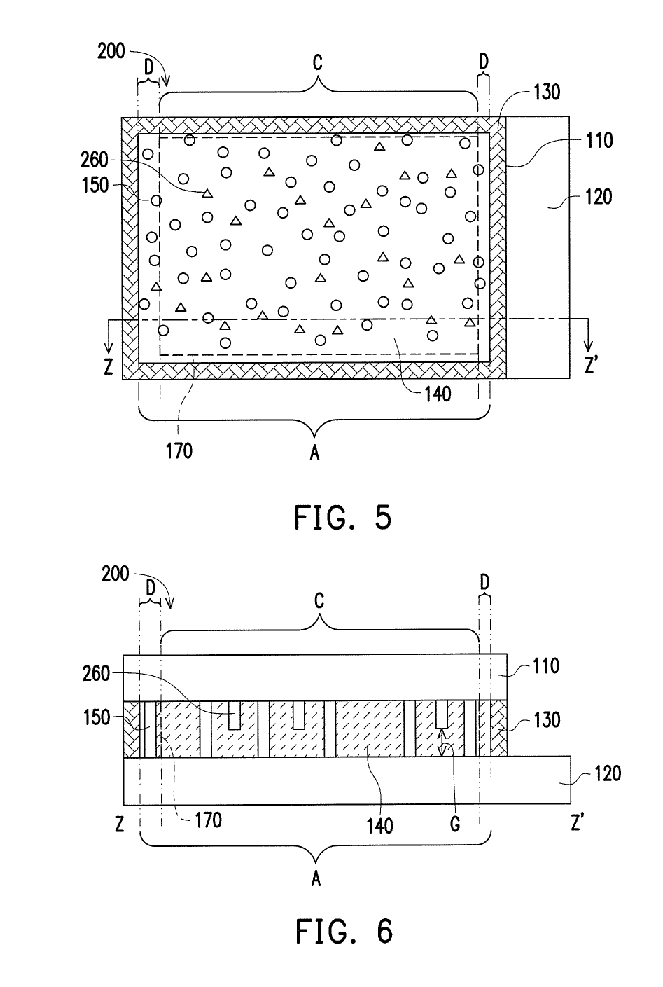

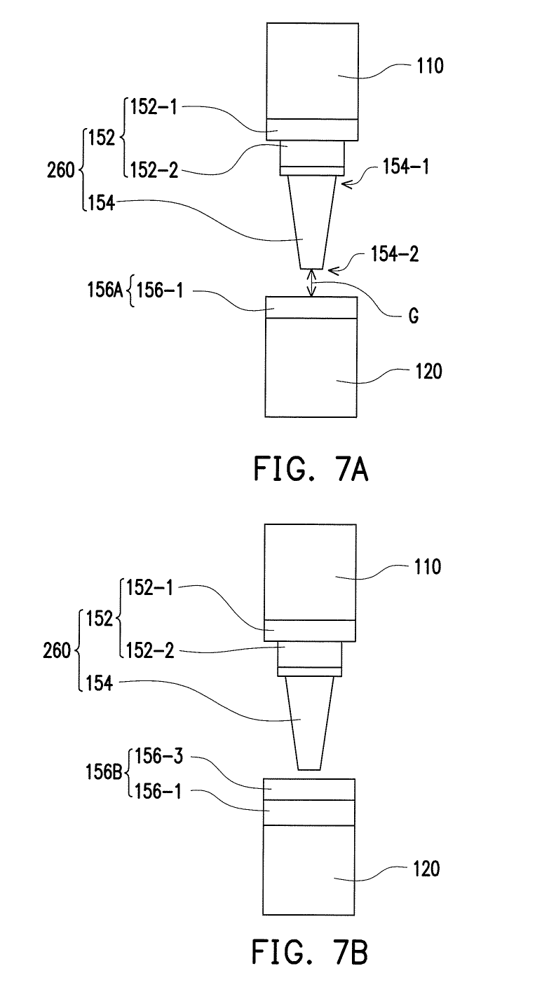

FIG. 5 is a top view illustrating a display panel according to another embodiment of the invention. FIG. 6 is a sectional schematic view illustrating the display panel shown by FIG. 5 along sectional line Z-Z′. Referring to both of FIGS. 5-6, a display panel 200 includes the first substrate 110, the second substrate 120, the seal 130, display medium 140, the plurality of first supporting structures 150 and a plurality of second supporting structures 260. The embodiments illustrated by FIGS. 1 and 2 may provide reference for the design and configuration of the first substrate 110, the second substrate 120, the seal 130, the display medium 140 and the plurality of first supporting structures 150. In the meantime, the elements denoted by same reference numbers in the two embodiments are similar; therefore, the descriptions are not repeated herein. In addition, the second supporting structures 260 in the embodiment are also disposed between the first substrate 110 and the second substrate 120 and located in the set area A.

When the display panel 200 is pressed by an external force, the display panel 200 is dented in responding to the external force. At this time, the display medium 140 flowing in the display panel 200 spreads everywhere from the force application point, causing that the height of the force application point is different from the height of other regions. As a result, the color distribution is uneven and the visual quality of display frame is bad. Therefore, the second supporting structure 260 in the embodiment is designed for providing a supporting force as appropriate when the display panel 200 is pressed so as to solve the above issue. Specifically, when an external force is applied to the display panel 200, a second end 154E of the column 154 in the second supporting structure 260 abuts against the element of the second substrate 120. At this time, since the second supporting structure 260 provides an abutting effect, after the pressing force is removed, the substrate and the display medium at the force application point may resume to the original state quickly, thereby reducing display unevenness caused by external force applied to the display panel 200.

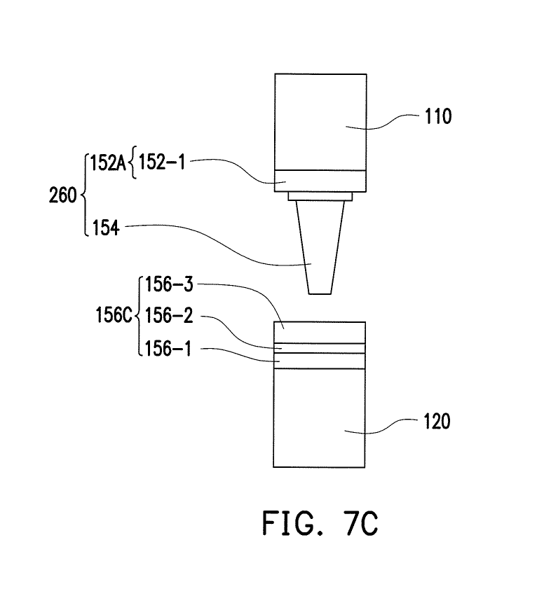

In the embodiment, no additional manufacturing process is required for the second supporting structure 260. The second supporting structure 260 is manufactured at the same time as the first supporting structure 150 is manufactured. However, the stack structure of the second supporting structure 260 is different from the stack structure of the first supporting structure 150. FIG. 7A is an enlargement view illustrating of the second supporting structure and a portion of the second substrate shown by FIG. 6. FIG. 7A shows that each second supporting structure 260 incudes a color filter layer stack 152 and a column 154. The color filter layer stack 152 is disposed between the column 154 and the first substrate 110, and a first end 154-1 of the column 154 is connected to the color filter layer stack 152. The area of the column 154 at the first end 154-1 fully contacts the color filter layer stack 152. The second end 154-2 of the column 154 and the second substrate 120 do not directly contact each other with a gap G formed therebetween. A portion of the display medium 140 exits in the gap G. Furthermore, in the embodiment, the sectional area of the column 154 gradually decreases toward the second substrate 120 from the first substrate 110. In another embodiment, in the process of manufacturing the first supporting structure 150, the exposing energy or type and property of developing agent may be adjusted so that the column 154 may be formed in the manner that the sectional area of the column 154 at the first end 154-1 is identical with the sectional area of the column 154 at the second end 154-2.

In the embodiment, the color filter layer stack 152 includes a light shielding layer 152-1 and a filter layer 152-2, wherein the light shielding layer 152-1 is disposed between the filter layer 152-2 and the first substrate 110. Moreover, the filter layer 152-2 is disposed between the light shielding layer 152-1 and the first substrate 110. The column 154 and the filter layer 152-2 may be directly in contact with each other.

In the embodiment, the second supporting structure 260 is configured in corresponding to an active element layer stack 156A. The active element layer stack 156A is disposed between the second substrate 120 and the display medium 140 in corresponding to the second end 154-2 of the column 154. A portion of the display medium 140 exists in the gap G between the active element layer stack 156A and the second end 154-2 of the column 154. The active element layer stack 156A includes a first metal layer 156-1, and the first metal layer 156-1 is disposed between the display medium 154 and the second substrate 120.

FIG. 7B is an enlargement view illustrating a second supporting structure according to another embodiment. FIG. 7B shows that the embodiment illustrated by FIG. 7B is approximately the same as the embodiment illustrated by FIG. 7A. Meanwhile, the elements denoted by same reference number in the two embodiments are designed in the same manner; therefore, the descriptions are not repeated herein. Compared with the embodiment illustrated by FIG. 7A, the active element layer stack 156B further includes a second metal layer 156-3, and the first metal layer 156-1 is disposed between the second metal layer 156-3 and the second substrate 120.

FIG. 7C is an enlargement view illustrating a second supporting structure according to another embodiment. FIG. 7C shows that the embodiment illustrated by FIG. 7C is approximately the same as the embodiment illustrated by FIG. 7A. Meanwhile, the elements denoted by same reference numbers in the two embodiments are designed in the same manner; therefore, the descriptions are not repeated herein. Compared with the embodiment illustrated by FIG. 7A, an active element layer stack 156C further includes a semiconductor layer 156-2. Moreover, a color filter layer stack 152A only includes a light shielding layer 152-1 without the filter layer 152-2 shown by FIG. 7A. The semiconductor layer 156-2 is disposed between the first metal layer 156-1 and the second metal layer 156-3. The first metal layer 156-1 is disposed between the semiconductor layer 156-2 and the second substrate 120. In addition, the light shielding layer 152-1 is disposed between the column 154 and the first substrate 110.

To sum up, in the invention, through adjusting the ratio of the supporting area of the first supporting structure to the region between the display region and the seal to be the same as the ratio of the supporting area of the first supporting structure in the display region to the display region, the heights of the cell gaps in the display region and the periphery region are identical, such that the edge mura effect may be reduced or mitigate. The ratio of the supporting area of the first supporting structure to the set area ranges from 0.03% to 0.08% or 0.04% to 0.06%. Furthermore, the second supporting structure is utilized in the invention to improve color unevenness caused by external force applied to the display panel so as to further enhance quality of the display frame.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A display panel, comprising:
a first substrate;
a second substrate opposite to the first substrate in a top-bottom manner;
a seal disposed between the first substrate and the second substrate, having a frame-like shape to define a set area;
a display medium disposed between the first substrate and the second substrate and located in the set area; and
a plurality of first supporting structures disposed between the first substrate and the second substrate and located in the set area, each of the first supporting structures abutting against the first substrate and the second substrate, each of the first supporting structures having a supporting area, and a ratio of the supporting areas of the first supporting structures to the set area being 0.03% to 0.08%.

2. The display panel according to claim 1, wherein the set area comprises a display region area and a periphery region area, the periphery region area is disposed between the display region area and the seal.

3. The display panel according to claim 2, wherein the first supporting structures are divided into a first portion in the display region and a second portion in the periphery region, a ratio of an overall supporting area of the first portion in the display region area to an area of the display region area is identical with a ratio of an overall supporting area of the second portion in the periphery region area to an area of the periphery region area.

4. The display panel according to claim 2, wherein the first supporting structures are divided into a first portion in the display region and a second portion in the periphery region, a ratio of an overall supporting area of the first portion in the display region area to an area of the display region area is 0.03% to 0.08%, and a ratio of an overall supporting area of the second portion in the periphery region area to an area of the periphery region area is 0.03% to 0.08%.

5. The display panel according to claim 1, wherein each of the first supporting structures comprises a color filter layer stack, a column and an active element layer stack, the color filter layer stack is disposed between the column and the first substrate, the active element layer stack is disposed between the column and the second substrate, a first end of the column abuts against the color filter layer stack, and a second end of the column abuts against the active element layer stack.

6. The display panel according to claim 5, wherein the supporting area of each of the first supporting structures is a contact area of the second end and the active element layer stack.

7. The display panel according to claim 5, wherein the active element layer stack comprises a first metal layer, a semiconductor layer and a second metal layer, the semiconductor layer is disposed between the first metal layer and the second metal layer, and the first metal layer is disposed between the semiconductor layer and the second substrate.

8. The display panel according to claim 5, wherein the color filter layer stack comprises a light shielding layer and a filter layer, and the light shielding layer is disposed between the filter layer and the first substrate.

9. The display panel according to claim 8, wherein the filter layer is a red filter layer, a blue filter layer, a green filter layer, a yellow filter layer or a white filter layer.

10. The display panel according to claim 5, wherein an area of the first end of the column fully contacts the color filter layer stack.

11. The display panel according to claim 1, further comprising a plurality of second supporting structures disposed between the first substrate and the second substrate and located in the set area, each of the second supporting structures protruding toward the second substrate from the first substrate and forming a gap, such that a portion of the display medium is located between the second supporting structure and the second substrate.

12. The display panel according to claim 11, wherein each of the second supporting structures comprises a color filter layer stack and a column, the color filter layer stack is disposed between the column and the first substrate, a first end of the column is connected to the color filter layer stack, and the portion of the display medium exits between a second end of the column and the second substrate.

13. The display panel according to claim 12, wherein the color filter layer stack comprises a light shielding layer, and the light shielding layer is disposed between the column and the first substrate.

14. The display panel according to claim 12, wherein the color filter layer stack further comprises a filter layer, and the filter layer is disposed between the light shielding layer and the column.

15. The display panel according to claim 11, further comprising an active element layer stack disposed between the second substrate and the portion of the display medium in corresponding to the second end of the column, and the portion of display medium being disposed between the active element layer stack and the second end of the column.

16. The display panel according to claim 15, wherein the active element layer stack comprises a first metal layer, the first metal layer is disposed between the display medium and the second substrate.

17. The display panel according to claim 16, wherein the active element layer stack further comprises a second metal layer, the first metal layer is disposed between the second metal layer and the second substrate.

18. The display panel according to claim 17, wherein the active element layer stack further comprises a semiconductor layer, the semiconductor layer is disposed between the first metal layer and the second metal layer, and the first metal layer is disposed between the semiconductor layer and the second substrate.
